(19) United States
(12) Patent Application Publication
(10) Pub. No.: US 2007/0230468 A1
(43) Pub. Date: Oct. 4, 2007

(54) Method to support mobile devices in a peer-to-peer network

(75) Inventors: Sathya Narayanan, Plainsboro, NJ (US); Eunsoo Shim, West windsor, NJ (US); David A. Braun, Danville, NJ (US)

Correspondence Address: RATNERPRESTIA, P.O. BOX 980, VALLEY FORGE, PA, 19482, US

(73) Assignee: Matsushita Electric Industrial Co., Ltd.

(21) Appl. No.: 11/395,085

(22) Filed: Mar. 31, 2006

(51) Int. Cl. H04L 12/56

(52) U.S. Cl. 370/392; 370/401

(57) ABSTRACT

A method for managing communications between or among nodes of a P2P network includes establishing a node ID, an IP address and a node type for each respective node to be joined or linked to the P2P network, the node type including at least a fixed node type or a mobile node type and identifying a type of the resource associated with a corresponding node. Fixed nodes are joined to form the P2P network. One of the joined nodes is selected for linking with a mobile type node based on a correspondence between the node IDs of the selected fixed node and the mobile node to be linked. The mobile node is linked to the selected node such that messages destined for the mobile node are routed via the selected node without updating any other node other than the selected node with the IP address of the mobile node.

### FIELD OF THE INVENTION

The present invention relates to the field of distributed networks generally and, in particular, a method for improved support of mobile devices in a peer-to-peer network.

### BACKGROUND OF THE INVENTION

Peer-to-peer (P2P) networks have become increasingly popular with their primary application being file-sharing. Others are using P2P networks for communication, such as Skype®, which has implemented a voice over Internet protocol (VoIP) P2P telephone service.

Distributed hash tables (DHTs) are used in certain P2P networks to improve efficiency of locating resources on these networks. In these P2P networks, a hash key (resource ID) is associated with a resource (e.g., a file) and each node in the system is responsible for storing a certain range of hash keys of a hash space. A lookup for a particular key is routed through the P2P network to the node responsible for the key using a specific routing algorithm. Node identifiers (Node IDs) are assigned to each node in the P2P network and are mapped to the same hash space as the resource IDs. Typically, in a DHT resources are assigned to a node having a node identifier (Node ID) that is closest, according to some location determination, to the resource ID. Details of the methods used to determine the location of the identifiers depend on the particular DHT mechanism being used. That is, each node is responsible for storing all resources that have a certain range of resource IDs. Nodes may exchange messages in response to a node joining or leaving to maintain the DHTs.

An exemplary Distributed Hash Table (DHT) is defined in an article by I. Stoica et al. entitled, “Chord: A Scalable Peer-To-Peer Lookup Service for Internet Applications,” in ACM SIGCOMM'01, August 2001. A large scale Chord network may be built using a huge hash key space, such as a set of 128 bit integers, and a cryptographic hash function, such as the SHA-1 function, defined in a standard entitled “Secure Hash Standard,” NIST, FIPS PUB 180-1, April 1995.

FIGS. 1A, 1B, 1C and 1D (Prior Art) are schematic diagrams of a conventional network using a Chord topology. FIG. 1A illustrates network resources used for the network and FIGS. 1B, 1C and 1D illustrate a conventional method of controlling mobile resources on the network when an IP address of the mobile resource is changed.

Referring now to FIG. 1A, a Chord P2P network 100 includes nodes with node IDs 0-15 (hereafter referred to as nodes 0-15) and resources (not shown) assigned identifiers from an identifier space. Network 100 may include a physical network 110, a plurality of physical nodes, 115, 120, 125, 130 and 135, and a plurality of processors 140, 145, 150, 155 and 160 (i.e., the processors may be, for example, one or more mobile devices 150 and/or one or more fixed devices 140, 145, 155 and 160) which communicate to each other via physical nodes 115, 120, 125, 130 and 135, respectively. Physical network 110 may include any number of physical nodes and corresponding processors. Each processor 140, 145, 150, 155 and 160 may include a finger table that forms a portion of a DHT 180 (see FIG. 1B).

In the example illustrated, the number of bits assigned to each identifier is 4 and, thus, the identifier space is 0-15. The number of bits, however, may be any number and may be denoted as m. Thus, the identifier space may consist of numbers from 0 to 2^{m}−1. Modulo 2^{m} is used for numeric operations and, thus, the identifier space may be ordered in a circular fashion, forming an identifier circle, called a Chord ring.

A resource identifier (resource ID) is a hash key generated from the name of the resource. For the hash function, cryptographic hash functions such as SHA-1 may be desirable to distribute resources uniformly in a large key space.

A resource with key k may be assigned to the first node having a node ID that is equal to or that follows k in Chord ring 100. Such a node is called the successor of key k, denoted by successor(k). Successor(k) is the first node clockwise from k in the Chord ring 100. Predecessor(k) is the first node counter-clockwise from k in the Chord ring 100. With respect to a particular node, for example, node 2, the next node in Chord ring 100 (e.g., as illustrated as the node which is the next in a clockwise orientation) is called its successor (i.e., node 9) and the previous node (the node counter clockwise) in the Chord ring 100 is its predecessor (i.e., node 0).

Each node is linked to (e.g., tracks), in a finger table m, other nodes called fingers that are the successors of keys n+2ⁱ⁻¹ for each i=1, . . . , m. For any particular node, the nodes identified in its finger table are neighboring nodes, since these nodes are reachable in one hop. Further, a particular node may keep track of its predecessor node. Each node has many entries pointing to nearby nodes, and fewer entries pointing to more remote nodes. These finger tables are populated when respective nodes join the Chord ring 100, and are maintained via communication among various nodes during the operation of Chord ring 100.

A resource with resource ID k is stored by successor(k). As nodes join or leave, resources may be stored on different nodes, so that information related to the joining or leaving nodes is exchanged to maintain P2P network funtionality. If a node failure occurs, redundant information maintained in the successor and predecessor nodes may be used to maintain Chord ring 100.

Communications may be routed based on a characteristic of the finger tables, namely that nodes have more information about other nodes (node IDs) closer to their identifer space than those further away. When locating a resource with a particular resource ID, for example, a lookup operation may be used.

The node initiating the operation (e.g., a first node or originator node) may forward a query to a node from its finger table (e.g., a second node) that is either successor(resource ID) or a node with the largest node ID that is smaller (modulo 2^{m}) than k. This process may be repeated, if necessary, from node to node until the node successor(k) is reached. That is, a second node may forward the query to another node (a third node) based on the finger table of the second node and this process may be repeated until successor(k) is reached. A finger of node n is successor(k) if the finger is the successor of n+2ⁱ⁻¹ for i such that key k is equal to or greater than n+2ⁱ⁻¹ and the finger's node ID is equal to or greater than key k. That is, for a certain i=1, . . . , m, n+2ⁱ⁻¹ ≦k≦successor(n+2ⁱ⁻¹), then successor(n+2ⁱ⁻¹) is also successor(k). During the forwarding steps, the query may reach predecessor(k). The successor of predecessor(k) is successor(k), and thus predecessor(k) forwards the query to successor(k). A node knows if it is successor(k) if its predecessor's node ID is smaller than key k (modulo 2^{m}). Upon receiving the query, successor(k) may reply to the query originator (the first node) with the requested information corresponding to the key if it has the information requested in the query. Otherwise, successor(k) replies to the query originator with a lookup failure message. In a Chord ring that has N nodes, the query reaches successor(k), on average, in log(N) hops . That is, if the Chord ring has 64,000 nodes, any query for resource k, on average, takes 16 hops to reach successor(k). This characteristic is the same for many known DHTs such as Chord networks, Pastry networks, and Tapestry networks, among others.

Typical query messages contain the target resource name or identifier and a Time-to-Live (TTL) value. Intermediate nodes forwarding the query messages may decrement the TTL value.

To facilitate proper operation of Chord ring 100, each node maintains its finger table and as nodes join or leave the Chord ring 100, the relevant finger table entries are automatically updated throughout Chord ring 100.

When a joining node requests to join network 100, the joining node applies a hash function to (i.e., hashs) an indentification value. This indentification on value is typically the IP address of the node connecting to Chord ring 100.

As illustrated in FIG. 1B, each processor 140, 145, 150, 155 and 160 (shown in FIG. 1A) includes a finger table that forms a portion of DHT 180. The finger tables include entries 180-1, 180-2, 180-3 and 180-4. It is understood by one of skill in the art that based on conventional chord methodologies as disclosed above, the entries in each finger table are as shown in FIG. 1B for a Chord ring having nodes 0-15 and processors associated with (joined at) nodes 0, 2, 9, 12 and 15.

As illustrated in FIG. 1C, when mobile node 9 (i.e., the node with node ID 9 having a mobile device connected thereto) changes its IP address and the node ID is derived from the IP address (i.e., the node ID is also changed), mobile node 9 sends a notification to the other nodes (i.e., nodes 12, 15 and 2) that are known to mobile node 9 that it is leaving Chord network 100 and that its successor and processor nodes are nodes 12 and 2, respectively. Nodes 12, 15 and 2 may update their finger tables to reflect that mobile node 9 is leaving. This may include: (1) node 12 updating its last finger table entry 180-4 to (4:12) to associate resource ID 4 with node 12; (2) node 15 updating its last two finger table entries 180-3 and 180-4 to (3:12) and (7:12), respectively, to associate resource IDs 3 and 7 with node 12; and (3) node 2 updating its first three finger table entries 180-1, 180-2 and 180-3 to (3:12), (4:12) and (6:12), respectively, to associate resource IDs 3, 4 and 6 with node 12.

As illustrated in FIG. 1D, after notifying nodes 12, 15 and 2 that it is leaving, the mobile device corresponding to mobile node 9 may change its IP address and may rejoin Chord network 100 at a node having a node ID associated with its changed IP address, in this example at mobile node 13. Because mobile node 13 knows that node 2 was its previous predecessor node, by joining Chord ring 100 at node 13, only nodes 12 and 15 (its predecessor and successor nodes) are notified of mobile node 13 joining Chord network 100.

Although, node 9 in the conventional Chord network is described as being a mobile node, this is for explanatory purposes only, as the Chord network 100 does not keep track of and does not treat differently mobile and fixed devices (or nodes).

The leaving and rejoining operation occurs when the node ID is strongly related to (or derived from) the IP address of a device coupled to the node. In other cases when the IP address changes, updates to finger table entries on other peers in the P2P network may occur such that the load on the P2P network is equivalent to that of a joining operation in terms of the number of messages that are sent. Although the traffic on the network is less if the node ID is not changed compared to if it changes, it is still large, in particular, for large scale networks.

The management overhead to maintain nodes having mobile devices associated with them may, thus, represents a large burden in traffic for a network, a burden that increases as the number of mobile devices increases.

### SUMMARY OF THE INVENTION

The present invention is embodied in a method for managing communications between or among nodes of a P2P network. The method includes establishing a node ID, an address and a node type for each respective node to be joined or linked to the P2P network. Each node ID identifies a corresponding node and is associated with a corresponding network resource. The node type of the node includes at least one of a first node type or a second node type and identifies a type of network resource associated with the corresponding node of the P2P network. One or more nodes of the first node type are joined to the P2P network. One of the joined nodes is selected to link with a node of the second type based on a correspondence between the node IDs of the selected node of the first node type and the node to be linked of the second type. The node of the second node type is then linked to the selected node of the first type such that messages destined for the node of the second type are routed via the selected node of the first type without updating any other node other than the selected node with the address of the node of the second type.

The present invention may also be embodied in a method for managing communications between or among nodes of a P2P network, each node including a finger table. The method includes establishing the node ID, an address and the node type for a respective node to be joined or linked to the P2P network. Each node is identified by a node ID associated with a corresponding network resource and by at least one of a first node type or a second node type, the second node type being different from the first node type. The method further includes selecting a node of the first type joined to the P2P network for linking with a node of the second type based on a correspondence between the node ID of the selected node of the first node type and the node of the second type to be linked. The node of the second node type is linked to the selected node of the first type and messages destined for the node of the second type are then routed via the selected node of the first type.

The present invention may also be embodied in a method for managing communications between or among nodes of a P2P network, each node being either a fixed or mobile node. The method includes joining a plurality fixed nodes to the P2P network and establishing a surrogate node from the plurality of fixed nodes through which messages to a mobile node are directed. Messages are routed through the established surrogate node when the destination of the message is the mobile node. A change message is routed, when an address of the mobile node is changed, from the mobile node to the surrogate node to change the address of the mobile node without changing a linkage between the surrogate node and the mobile node such that messages for the mobile node are directed through the surrogate node before and after the address of the mobile node is changed.

### BRIEF DESCRIPTION OF THE DRAWINGS

The invention is best understood from the following detailed description when read in connection with the accompanying drawings. It is emphasized that, according to common practice, various features/elements of the drawings may not be drawn to scale. Moreover in the drawings, common numerical references are used to represent like features/elements. Included in the drawing are the following figures:

FIG. 1A (Prior Art) is a schematic diagram of a conventional peer-to peer network;

FIGS. 1B, 1C and 1D (Prior Art) are schematic diagrams of the conventional peer-to peer network of FIG. 1A illustrating a conventional method for leaving and rejoining of a mobile device when an IP address of a mobile device is changed;

FIG. 2 is a schematic diagram illustrating a P2P network in accordance with an exemplary embodiment of the present invention;

FIG. 3 is a schematic diagram illustrating the joining of a mobile node to the P2P network of FIG. 2;

FIG. 4 is schematic diagram illustrating the search for a resource in the P2P network of FIG. 3;

FIG. 5 is a flow chart illustrating a method of managing communication in accordance with another embodiment of the present invention; and

FIG. 6 is a flow chart illustrating a method of managing communication in accordance with yet another embodiment of the present invention.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

Problems can occur in a conventional P2P network when a mobile device which is established as a node on the P2P network (i.e., a mobile node) moves thereby causing the mobile device to have a new IP address. The new IP address of the mobile device may have the same effect on the P2P network as if the node with the node ID corresponding to the old IP address of the mobile device leaves the P2P network and a node with the node ID corresponding to the new IP address of the mobile device joins the P2P network. Otherwise, in a conventional P2P network, such a change in the IP address of a mobile node causes other nodes (i.e., peers) to update their finger table entries in the P2P network such that the load on the P2P network due to the IP address change is equivalent to that of a joining operation in terms of the number of messages that are sent. Churning (i.e., excess message traffic) due to changes in IP addresses (i.e., excessive leaves and rejoins) may occur in either case causing degradation in network performance.

Although certain exemplary embodiments are described in terms of a Chord or a peer-to-peer network, they may be applied to other networks employing DHT's. For example, they may apply to other P2P networks including CAN networks, Pastry networks, and Tapestry networks, among others. Moreover, the term finger table may be generalized in such networks to routing table and the terms successor and predecessor nodes may be generalized in such networks to refer to: (1) nodes that neighbor a particular node (in proximity to the particular node based on the structure of the identification space); (2) nodes that are in the routing table of the particular node or (3) nodes that are known to the particular node.

It is contemplated that certain exemplary embodiments of the present invention may include identifying each node as either a mobile node (i.e., a node corresponding to a mobile device) or a fixed node (i.e., a node corresponding to a fixed device) based on devices corresponding to these nodes and linking each node identified as a mobile node with its closest fixed node (i.e., a node corresponding to a fixed device) such that a communication to the mobile node is routed via the closest fixed node. Closeness here is defined same as the closeness used for linking given resource ID to a node ID, i.e. a fixed node that will be linked to the resource ID same as the mobile node's ID will be the closest fixed node for that mobile node.

It is further contemplated that certain exemplary embodiments of the present invention may include node finger tables in which the node IDs of the mobile nodes refer to the closest fixed node (i.e., its IP address)such that when an IP address of the mobile node is changed, a linkage between the mobile node and its closest fixed node ID is maintained. This enables messages to continue to be routed via the closest fixed node after the IP address of the mobile node is changed.

It is also contemplated that certain exemplary embodiments of the present invention may include mobile registration messages to change the IP addresses of respective mobile nodes. The mobile registration messages may be sent to the closest fixed node in the node ID space. These registration messages may include the changed IP addresses such that the closest fixed node maintains responsibility for the mobile node before and after the IP address changes and other nodes in the P2P network continue to route messages destined for the mobile node via the closest fixed node.

It should be understood that the method illustrated may be implemented in hardware, software, or a combination thereof. In such embodiments, the various components and steps described below may be implemented in hardware and/or software.

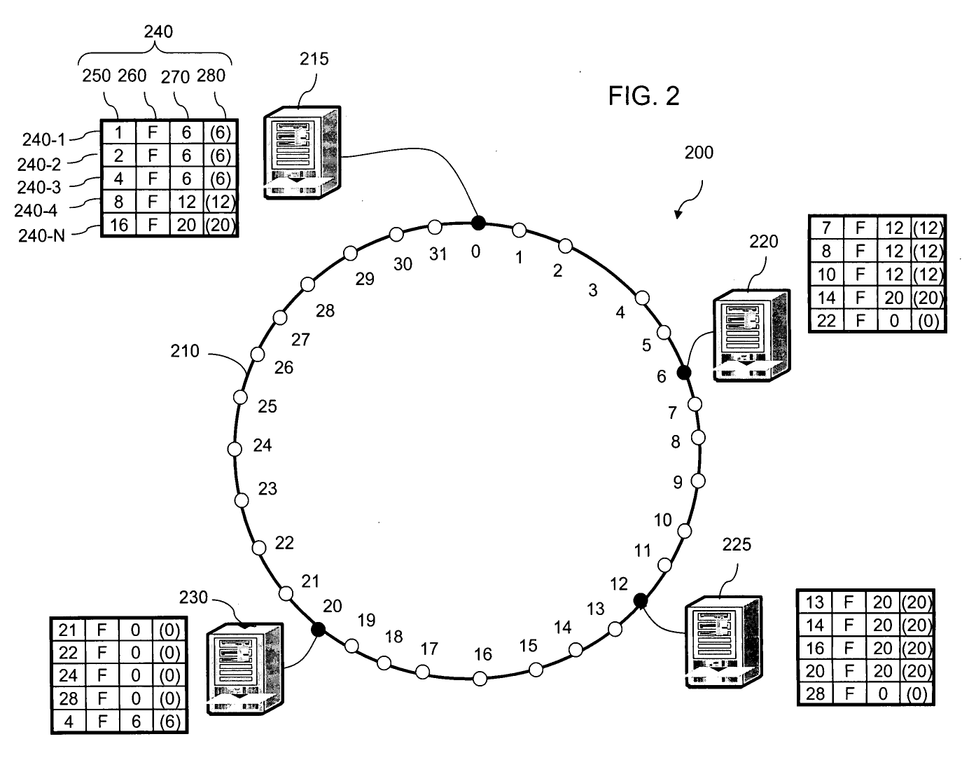

FIG. 2 is a schematic diagram illustrating a P2P network in accordance with an exemplary embodiment of the present invention.

Referring now to FIG. 2, Chord P2P network 200 includes logical nodes 0-31 and resources (not shown) assigned identifiers from an identifier space. Network 200 may further include a physical network 210, a plurality of processors 215, 220, 225 and 230, and a corresponding plurality of physical nodes (i.e., network connections, for example network cards of the plurality of processors 215, 220, 225, and 230). Physical network 210 may include any number of physical nodes and corresponding processors. Each processor 215, 220, 225 and 230 may include a finger table that forms a portion of DHT 240. Each processor 215, 220, 225 and 230 may include other connected resources (not shown) and each processor 215, 220, 225 and 230 and the other connected resources may vary in the size (i.e., storage capacity and processor power) and in the bandwidth of the connection to network 200. Network 200 may include mobile nodes and fixed nodes. Mobile nodes refer to nodes having mobile devices coupled thereto (i.e., devices capable of movement to another node on network 200 such as: (1) mobile computers; (2) electronic devices, for example, Personal Digital Assistants (PDAs), cell phones, and (3) other internet appliances, among others). Fixed nodes refer to nodes having substantially fixed, permanent or non-movable devices coupled thereto (i.e., devices which are generally not capable of movement to another node on network 200).

The operation of the DHT 240 is similar to the operation of the DHT 180 of the conventional art related to fixed nodes (i.e., nodes having corresponding devices which are substantially permanent, fixed or non-movable). DHT 240 may include, however, at least one additional field for each finger table entry 240-1, 240-2, 240-3, 240-4 and 240-N. The additional field may include: (1) a node type field 260 and/or other fields that include information such as connection specific information or device specific information, for example, to improve management of network 200. In certain embodiments, the fields may include, for each finger table: (1) a resource ID field 250; (2) the node type field 260; (3) a node ID field 270; and (4) an IP address field 280.

The portion of DHT 240 in each node may include the conventional DHT information regarding resource ID field 250, and node ID field 270. Other information in addition to the conventional DHT information may be added to improve the performance of the network by including, for example, device specific information. The node type field, for example, may indicate if the device coupled to the node is a mobile device, as indicated by an “M” in this field or a fixed device, as indicated by an “F” in this field. IP address field 280 may store information indicating the IP address of the node ID in node ID field 270, when a fixed node type is indicated in node type field 260, or it may store information indicating the IP address of the closest fixed node of the node ID in node ID field 270, when a mobile node type is indicated in node type field 260.

The designations of “M” and “F” are for exemplary purposes and may be any other designation including, for example a binary 1 and a binary 0, respectively, among many others. In certain exemplary embodiments, the IP address field 280 may indicate the IP address of the closest successor node or the IP address of the closest predecessor node that corresponds to a fixed device for a particular mobile device. That is, a mobile node may be linked to a fixed surrogate node using the IP address field 280.

In other words, when node type field 260 for a finger table entry indicates a mobile node type (i.e., “M”), the node ID field 270 for that finger table entry may indicate the node ID of the mobile node (the node corresponding to the mobile device) and IP address field 280 may indicate an IP address of a surrogate node (i.e., the closest fixed node). However, when node type field 260 for the finger table entry indicates a fixed node type (i.e., “F”), node ID field 270 for that finger table entry may indicate the node ID of this fixed node and IP address field 280 may indicate its IP address. In this way, fixed nodes are managed in the same way nodes on a conventional P2P network are managed. However, mobile nodes are managed differently from fixed nodes.

Because all of the devices illustrated in FIG. 2 are fixed devices, each of the finger table entries for node type field 260 indicates a fixed node by the designation “F”. For each of the finger table entries, the IP address field 280 corresponds to the node IDs in the respective node ID field 270 and the DHT 240 maintains node joins, node leaves and node-to-node communications similar to those of the conventional methods described above.

In certain exemplary embodiments, the node ID of devices on the P2P network may be derived independently of the IP addresses of the devices that join or link to the P2P network for example through a random number generation, or through the use of port numbers, among others. Further, the node ID of mobile device 235 may be derived in a manner to improve security of the P2P network.

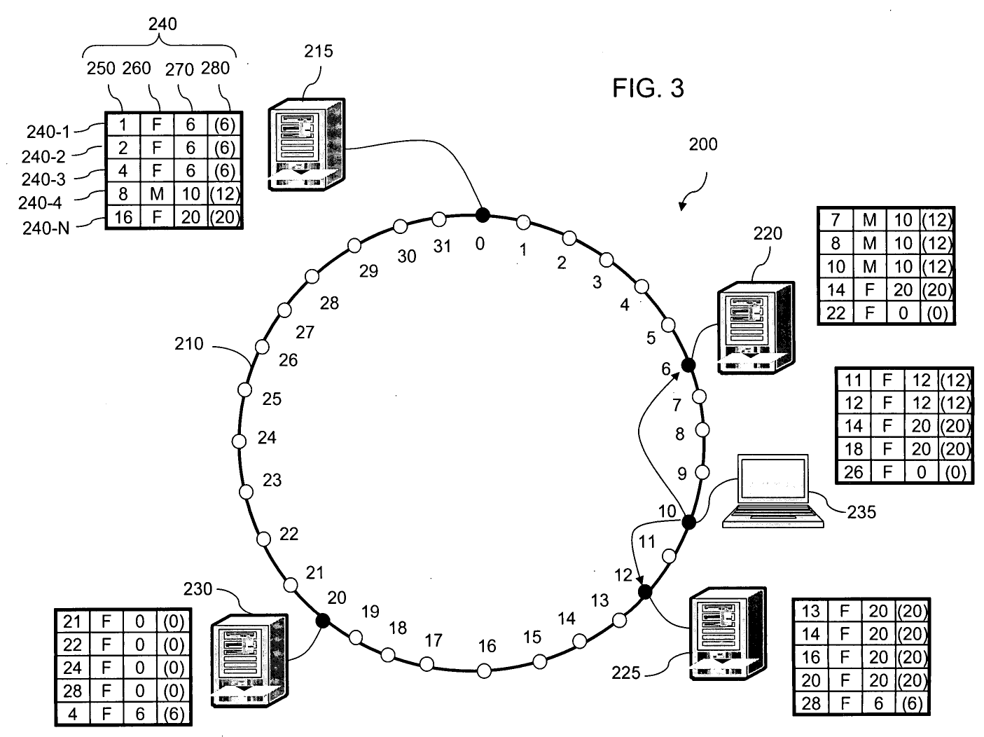

FIG. 3 is a schematic diagram illustrating the joining of a mobile node to network 200 of FIG. 2.

Referring now to FIG. 3, when a mobile device 235 joins P2P network 200, mobile device 235 may establish a node ID. The node ID may be derived independently of the IP address of mobile device 235, for example, as a randomly generated value and it may be hashed (i.e., by applying a hash function). A linking message (e.g., join message) may be sent to the required nodes (in this example, nodes 0, 6 and 12) corresponding to mobile node 10 of mobile device 235. At the end of the join operation any routing table entry referring to node ID 10 will have the type set as ‘M’ and the IP address referring to the closest fixed node of 10, i.e. node 12. A separate registration message to the closest fixed node (in this example node 12) is sent binding the node ID 10 to the IP address of 10, indicated by (10).

Predecessor node 6 may update its finger table to reflect the linking of mobile node 10 to P2P network 200. In particular, the finger table 240 of predecessor node 6 may update its finger table entries 240-1, 240-2 and 240-3 to (7:M:10:(12)), (8:M:10:(12)) and (10:M:10:(12)), respectively, where (N) indicates the IP address of node N. That is, because the node responsible for resource IDs 7, 8 and 10 is the mobile node 10, an “M” is indicated in the corresponding finger table entries 240-1, 240-2 and 240-3 in the node type field 260. Further, in these finger table entries in the node ID field, the node ID of mobile node 10 is indicated.

Each node may maintain a registration table (not shown) that includes registration information related to linkages of mobile nodes. In certain embodiments, this registration table is maintained for only fixed devices (i.e., corresponding to fixed nodes). After the linking message is received by surrogate node 12 (i.e., the closest fixed node type relative to mobile node 10), information regarding at least the node type and IP address of the mobile node may be updated in the registration table of surrogate node 12.

Because the finger table entries of nodes which point to a respective mobile node include the node IDs of the respective mobile nodes (which does not change when its IP address changes) and the IP address of their respective closest fixed node, when the IP address of the respective node changes, only the registration table of the closest fixed node is updated. That is, no finger table entries for any node in the P2P network needs to be updated.

Although the P2P network 200 is illustrated as using Internet Protocol (IP) addresses, it is contemplated that the P2P network may include any type of contractor or locator addresses including IP complaint addresses and/or other types of addresses.

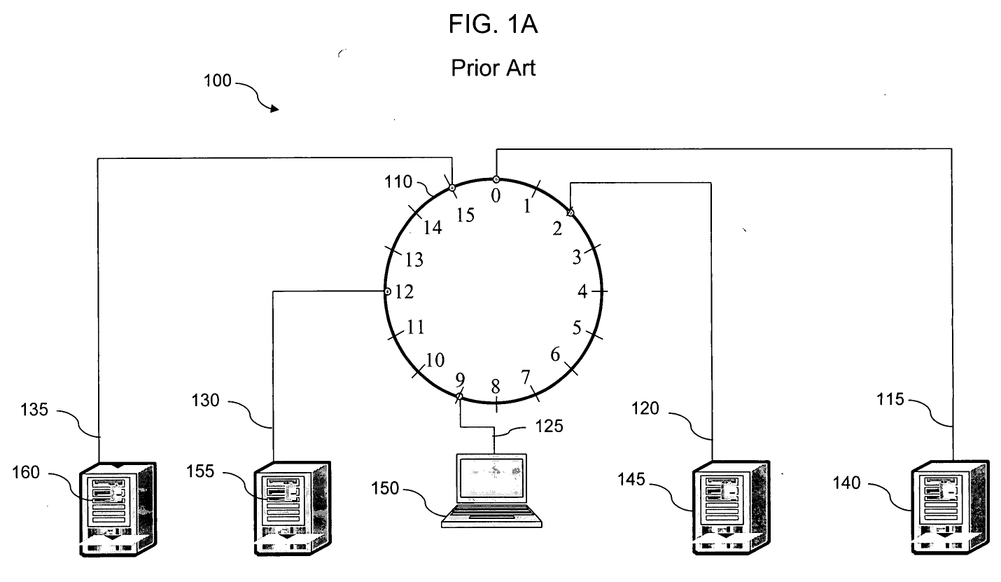

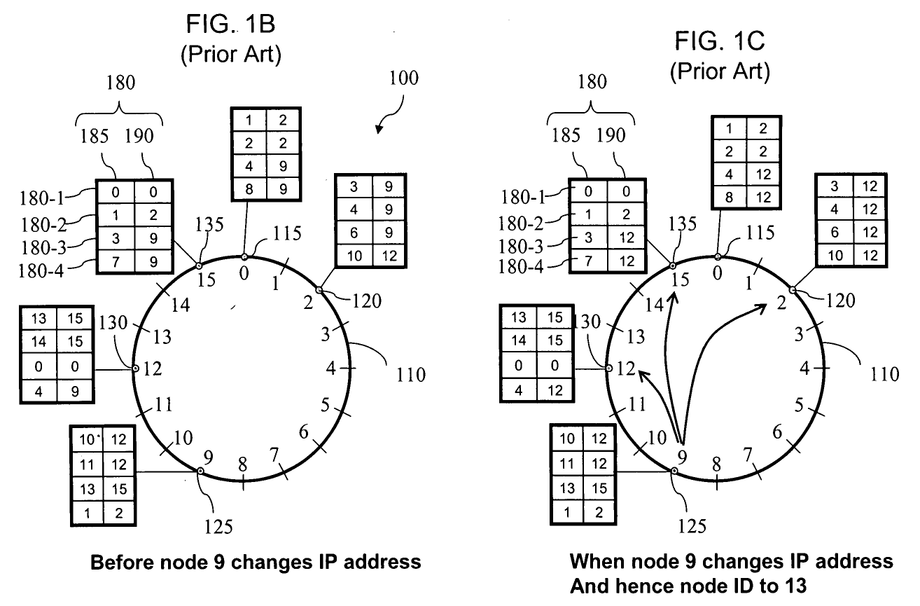

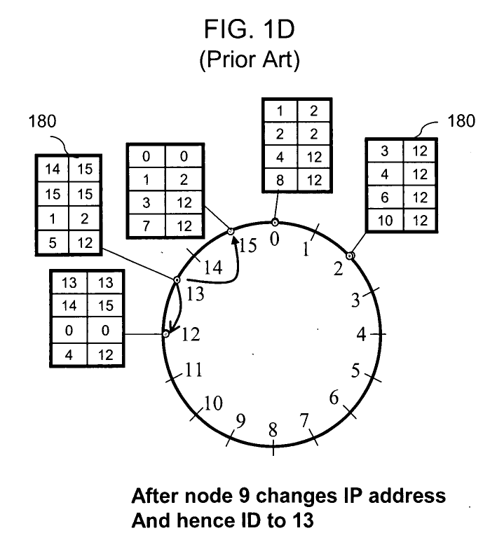

In certain exemplary embodiments, when the IP address of the mobile node changes: (1) the registration table of the closest fixed node may be updated without updating any finger table in the P2P network 200. This is because: (1) nodes with mobile devices may change their IP addresses by sending a registration message to the closest fixed node that updates only the registration table; and (2) the node ID of the mobile node, which is stored in finger table entry that points to the surrogate of the mobile node, is not derived from its IP address and, thus, does not change when the IP address changes. In these exemplary embodiments, the amount of overhead traffic for an IP address change for a mobile node is substantially reduced compared to the overhead traffic for a conventional P2P network as illustrated in FIGS. 1A, 1B, 1C and 1D.

In the conventional P2P network 100 (as shown in FIGS. 1A, 1B, 1C and 1D), the joining of a node corresponding to, for example, mobile device 125 is communicated (propagated) to all or substantially all nodes in P2P network 100. Moreover, if mobile device 125 changes its IP address, a leaving message and a subsequent joining message, based on a changed node ID, may be propagated to all or substantially all nodes in P2P network 100. This can create excessive churn in the conventional P2P network 100. In other conventional P2P networks where the node ID and IP addressed are not tightly linked (e.g., the node ID is not derived form the IP address) at least one message to update the IP address of the mobile node is propagated to all or substantially all nodes in the P2P network.

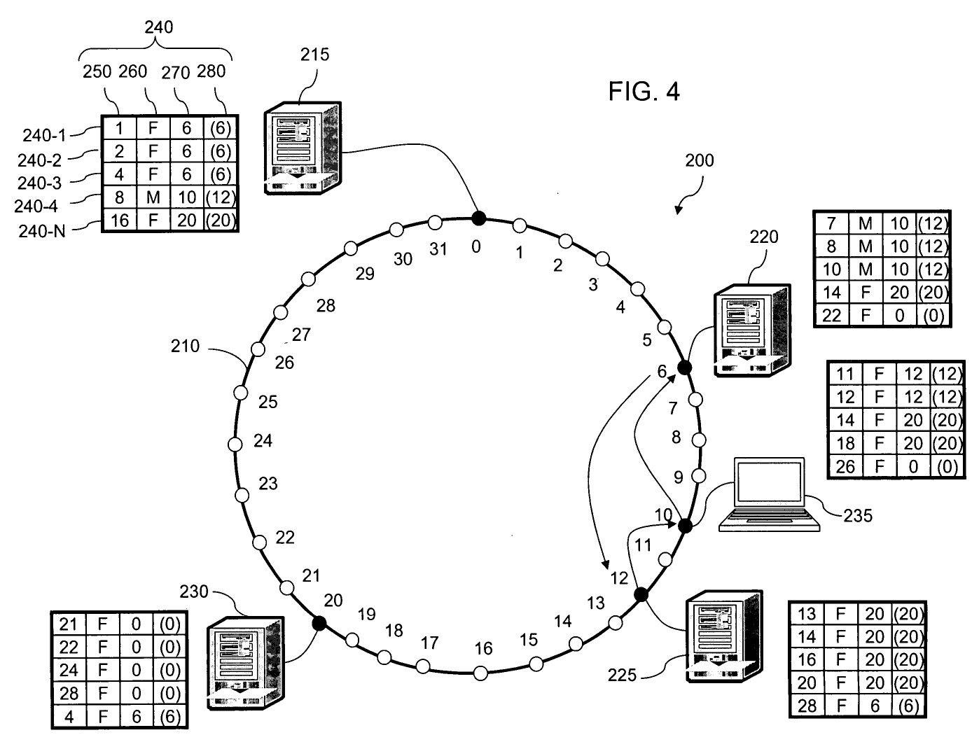

FIG. 4 is a schematic diagram illustrating the search for a resource in network 200 of FIG. 3.

Referring now to FIG. 4, when a lookup message is destined for mobile node 10 (i.e., that is, when a resource with a resource ID managed by mobile node 10 is needed) and the message is received by fixed predecessor node 6, fixed predecessor node 6 determines by its finger table entry 240-3 that node 10 is a mobile node (i.e., has mobile device 235 connected thereto and that mobile node 10 is linked to (registered with) surrogate node (fixed node) 12. The lookup message is sent to surrogate node 12 which routes the lookup message directly to mobile node 10. In this way, the surrogate fixed node stands in for mobile node 10 and, thus, communications to mobile node 10 are via surrogate node 12.

In certain exemplary embodiments, mobile node 10 may respond to the lookup message by sending a reply message (either a lookup failure or the resource information) directly to the node requesting the information (i.e., either node 6 or some other preceding node that initiated the lookup request). In other exemplary embodiments, the reply message may be forwarded via surrogate node 12.

Although only one mobile node is illustrated as being registered (linked) to a surrogate node, it is contemplated that any number of mobile nodes may exist on the P2P network.

By linking (registering) mobile nodes to surrogate nodes (fixed nodes), overhead communications (e.g., for joining and leaving of mobile nodes) for network 200 may be significantly reduced, in particular, when these mobile nodes on network 200 have a high churn rate for their IP addresses.

Although it is illustrated that each mobile node is registered with one fixed node, it is contemplated that each mobile node may be registered with any number of fixed nodes in the P2P network. Such a redundant structure enables routing of messages even if one or more of these fixed nodes is offline or inactive, as long as one of the fixed nodes having the mobile node registered thereto is active. The number of redundant registration node (fixed nodes) may be based on the reliability in reaching the mobile node and the probability of one or more fixed nodes being offline. That is, the registration information may be replicated in one or more other nodes, for example, a sequence of one or more successors of the surrogate node to ensure against for example, the surrogate node crashing or, otherwise, being offline or inactive.

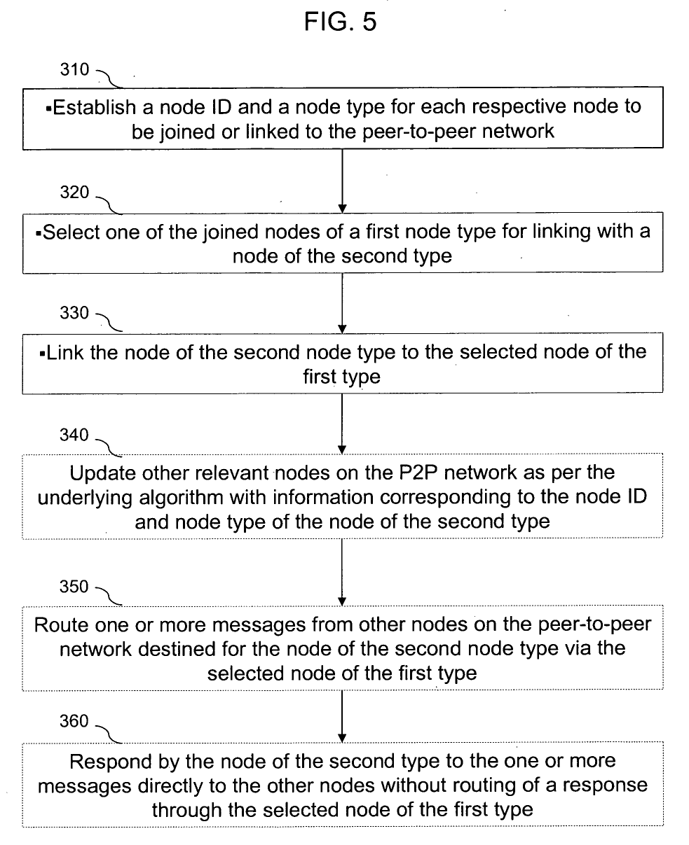

FIG. 5 is a flow chart illustrating a method of managing communication in accordance with certain embodiments of the present invention.

Now referring to FIG. 5, the method manages communication between or among nodes of network 200. At block 310, a node ID and a node type for each respective node to be joined or linked to network 200 may be established. Each node ID may identify a corresponding node and may be based on a corresponding network resource. The node types may include two or more, for example, of a mobile node type and a fixed node type. The node types may identify a type of the network resource associated with the corresponding node of network 200. One or more nodes of the fixed node type (i.e., one or more fixed nodes) may be joined to network 200.

At block 310, one of the joined nodes may be selected for linking with a node of the mobile type (i.e., a mobile node) based on a correspondence between the node IDs of the selected fixed node (surrogate node) and of the mobile node to be linked.

At block 320, the mobile node may be linked to the surrogate node by sending a mobile registration message from the mobile node to the surrogate node. The mobile registration message may update the registration table (not shown) of the surrogate node. At least each fixed node may include a registration table that contains information corresponding to the node ID, the IP address and node type of corresponding linked mobile nodes. This information may be maintained and updated by mobile registration messages sent from respective mobile nodes establishing or changing linkages to respective surrogate nodes.

At block 340, in certain exemplary embodiments, the closest predecessor node (e.g., a fixed node) of the surrogate node may also be updated with information (e.g., corresponding to the node ID, the IP address and node type) corresponding to the mobile node. That is, the surrogate node at block 320 and the fixed predecessor node that is a closest predecessor to the surrogate node at block 340 may be updated.

At block 350, in some exemplary embodiments, messages destined for the mobile node may be routed via the surrogate node. One or more messages may be routed from other nodes of network 200 destined for the mobile node via the surrogate node and the mobile node may reply in a reply message directly to the other nodes without routing the reply message through the surrogate node. That is, these messages are routed to the surrogate node based on the IP address in IP address field 280 and then forwarded to the mobile node using the IP address stored in the registration table.

Also, in certain exemplary embodiments, communication with intermediate nodes may be accomplished using only fixed nodes (based on routing using information stored in respective finger tables) with the possibility of the last-hop routing being to a mobile node. The last-hop routing of a communication to such a mobile node is based on information stored in the registration table of the fixed surrogate node.

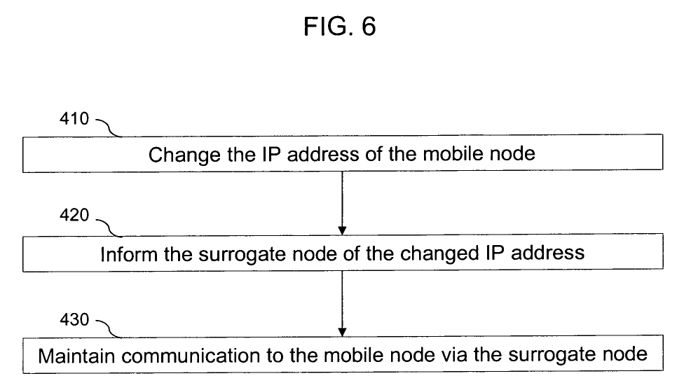

FIG. 6 is a flow chart illustrating a method of managing communication in accordance with yet another embodiment of the present invention.

Now referring to FIG. 6, the method also manages communication between or among nodes of network 200. At block 410, the mobile node may change its IP address.

At block 420, a message (e.g., a registration message) that the IP address of the mobile node has changed may be sent from the mobile node to the surrogate node.

At block 430, communication from other nodes in the peer-to-peer network to the mobile node continues to be routed through the surrogate node. That is, communication is maintained to the mobile node via the surrogate node.

Although the node type is shown to be either fixed or mobile nodes (i.e., two different mobility levels for a network device), it is contemplated that other mobility levels are possible. For example, as the frequency of movement of a device increases, the number of surrogate nodes may decrease. That is the linking process may be tailored to update, for example, any number of successor nodes based on the level of mobility indicated by the node type.

Although the node type is shown to be either fixed or mobile nodes, it is further contemplated that the node type may indicate a priority of each respective node of the peer-to-peer network such that lower priority nodes are configured to communicate via higher priority nodes. It is also contemplated that the node type, otherwise, may indicate a connection type of the respective node such that a direct linkage to one or more other nodes on the peer-to-peer network may be established to pass information directly between or among these nodes.

By identifying each node with a node type (e.g., mobile or fixed) and linking each node identified as a mobile node with a fixed node, communications to the mobile node may be routed via one or more fixed nodes to the mobile node, thereby providing significantly reduced overhead communications to link a mobile node to the P2P network.

Although the invention has been described in terms of a method for managing a P2P network using a DHT, it is contemplated that it may be implemented in software on microprocessors/general purpose computers. In various embodiments, one or more of the functions of the various components may be implemented in software that controls a general purpose computer. This software may be embodied in a computer readable carrier, for example, a magnetic or optical disk, a memory-card or an audio frequency, radio-frequency, or optical carrier wave.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for managing communications between or among nodes of a peer-to-peer network, the method comprising the steps of:
a) establishing a node ID, an address and a node type for each respective node to be joined or linked to the peer-to-peer network, each node ID identifying a corresponding node associated with a corresponding network resource, the node type including at least one of a first node type or a second node type identifying a type of the network resource associated with the corresponding node of the peer-to-peer network, one or more nodes of the first node type being joined to form the peer-to-peer network;
b) selecting one of the nodes of the first type for linking with a node of the second type based on a correspondence between the node IDs of the selected node of the first node type and the node of the second node type; and
c) linking the node of the second node type to the selected node of the first type such that messages destined for the node of the second type are routed via the selected node of the first type without updating any other node other than the selected node with the address of the node of the second type.

2. The method according to claim 1, wherein step (c) of linking the node of the second node type to the selected node of the first type includes the steps of:
maintaining a registration table in the selected node of the first type including information corresponding to the address and node type of the node of the second type.

3. The method according to claim 1, wherein nodes of the first node type are fixed nodes, each fixed node identifying a corresponding network resource associated therewith, as being substantially non-movable and nodes of the second node type are mobile nodes, each mobile node identifying the corresponding network resource associated therewith, as being movable.

4. The method according to claim 3, wherein step (c) of the linking the mobile node includes:
establishing, in the selected node, a node ID and an address of the mobile node.

5. The method according to claim 3, wherein when the address of the mobile node is changed, step (c) of the linking the mobile node includes
updating, in the selected node, the changed address of the mobile node without changing a linkage of the mobile node to the selected node.

6. The method according to claim 4, wherein the linking of the mobile node includes:
propagating to other nodes in the P2P network having the mobile node as an entry in respective routing tables, the node type of mobile node, the node ID of the mobile node and the address of the surrogate node.

7. The method according to claim 1, further comprising the steps of:
d) routing one or more messages from other nodes on the peer-to-peer network destined for the node of the second node type via the selected node of the first type; and
e) responding, by the node of the second type, to the one or more messages directly to the other nodes without routing of a response through the selected node of the first type.

8. The method according to claim 1, wherein the peer-to-peer network is a chord network and step (c) of linking the node of the second node type to the selected node of the first type includes creating a link between the node of the second type and the selected node of the first type which corresponds to a next successor node relative to the node of the second type in the chord network.

9. The method according to claim 8, further comprising the steps of:
routing a message through the selected node of the first type responsive to the message destination being the node of the second type; and
passing the message directly to the node of the second type responsive to receipt of the message by the selected node of the first type.

10. The method according to claim 1, wherein the node type of each node includes a value indicating one of: (1) a priority of the respective node on the peer-to-peer network such that a lower priority node is configured to communicate via higher priority node; (2) a mobility of a resource device connected to each node such that higher mobility nodes update less nodes on the peer-to-peer network during a registration process than lower mobility nodes; or (3) a connection type of the respective node such that a direct linkage to another node on the peer-to-peer network is established to pass information directly therebetween.

11. A method for managing communications between or among nodes of a peer-to-peer network, each node including a routing table, the method comprising the steps of:
a) establishing a node ID, an address and a node type for a respective node to be joined or linked to the peer-to-peer network, each node being identified by the node ID associated with a corresponding network resource and by at least one of a first node type or a second node type, the second node type being different from the first node type;
b) selecting a node of the first type joined to the peer-to-peer network for linking with a node of the second type based on a correspondence between the node ID of the selected node of the first node type and the node ID of the second type to be linked;
c) linking the node of the second node type to the selected node of the first type; and
d) routing messages destined for the node of the second type via the selected node of the first type.

12. The method according to claim 11, further comprising the steps of:
e) joining a respective node of the first node type to the peer-to-peer network by sending a join message to other nodes in the peer-to-peer network; and
f) updating the routing tables of respective ones of the other nodes in the peer-to-peer network with information corresponding to the node ID, the IP address and the node type of the respective node of the first type joining to the peer- to-peer network.

13. The method according to claim 11, wherein step (c) of linking the node of the second node type to the selected node of the first type includes the steps of:
maintaining a registration table in the selected node of the first type including information corresponding to the node ID, the address and node type of the node of the second type.

14. The method according to claim 11, wherein:
each node of the first node type is a fixed node and each node of the second node type is a mobile node; and
step (c) of linking the mobile node includes:
changing the address of the mobile node, and
sending a message that the address of the mobile node has changed without changing the linkage from between the mobile node and the selected fixed node.

15. The method according to claim 11, wherein:
each node of the first node type is a fixed node and each node of the second node type is a mobile node;
each address is an IP address; and
the linking of the mobile node includes:
establishing the node ID and an IP address of the mobile node; and
registering the node ID and the IP address of the mobile node with the selected node to enable the routing of messages from the selected fixed node directly to the mobile node.

16. A method for managing communications between or among nodes of a peer-to-peer network, each node being either a fixed or mobile node, the method comprising the steps of:
a) joining a plurality of fixed nodes to the peer-to-peer network;
b) establishing a surrogate node from the plurality of fixed nodes through which messages to a mobile node are directed;
c) routing the messages through the established surrogate node when the destination of the message is the mobile node; and
d) routing a change message, when an address of the mobile node is changed, from the mobile node to the surrogate node to change the address of the mobile node without changing a linkage between the surrogate node and the mobile node such that messages for the mobile node are directed through the surrogate node before and after the address of the mobile node is changed.

17. The method of claim 16, wherein each of the routing tables of the plurality of nodes includes addresses of fixed nodes in the P2P network such that messages are routed using the routing tables to fixed intermediate nodes and are routed using registration tables to the mobile node.

18. A computer readable medium including software that is configured to control a general purpose computer to control communication from a device in the peer-to-peer network by implementing a method according to claim 1.

19. A computer readable medium including software that is configured to control a general purpose computer to control communication from a device in the peer-to-peer network by implementing a method according to claim 16.
